(19) United States
(12) Patent Application Publication
(10) Pub. No.: US 2025/0080652 A1
(43) Pub. Date: Mar. 6, 2025

(54) HUMAN SELECTION DIALING PLATFORM

(71) Applicants: Nicole McDonald, Austin, CA (US); Jeni Imperiale, Austin, CA (US); Jennifer Mansfield, Austin, CA (US)

(72) Inventors: Nicole McDonald, Austin, CA (US); Jeni Imperiale, Austin, CA (US); Jennifer Mansfield, Austin, CA (US)

(21) Appl. No.: 18/240,276

(22) Filed: Aug. 30, 2023

(51) Int. Cl. H04M 3/51; H04M 3/523

(52) U.S. Cl. CPC H04M 3/5158; H04M 3/523

(57) ABSTRACT

Apparatuses and methods are presented herein that enable dialing missed inbound telephone calls (i) using human selection with (ii) no random generation of telephone numbers or random storage of missed inbound calls. Missed inbound calls can come from a number of sources, and the phone numbers are stored sequentially in a database. They may be deterministically classified into a number of queues according to a number of characteristics such as the telephone number itself, source of the call, time of day, time zone, day of the week, data source, DNC registry, etc. The queues may be directed to a call selector which deterministically presents a choice of numbers to dial to a human company representative at a workstation. The customer representative may select which number to call, adding the element of human choice to the process.

The present disclosure relates to telemarketing. More particularly, the present disclosure relates to an apparatus and method for redialing missed incoming phone calls in a deterministic manner.

### BACKGROUND

The Telephone Consumer Protection Act (TCPA) 47 USC Section 227 prohibits three activities relevant to the present disclosure. First, it prevents telephone solicitation calls and texts to residential numbers on the national Do Not Call (DNC) registry. Second, it prohibits the use of a prerecorded or artificial voice to deliver a message without the express consent of the called party. Finally, the TCPA prohibits the use of an Automated Telephone Dialing System (ATDS) to make calls or texts to a cellular phone without the express consent of the called party.

Systems that store phone numbers using a random or sequential number generator (including the use of such a generator in determining the sequence in which numbers are dialed) and systems that dial randomly created telephone numbers both qualify as ATDS usage. Storage of phone numbers using a random or sequential number generator alone is enough to trigger the TCPA.

Occasionally, potential customers may call a company but not be able to reach a company representative or a sales agent. These calls are very high value because the customer has expressed interest in the company's products and is thus more likely to respond positively to a sales pitch. A method of contacting those customers without triggering the TCPA is highly desirable.

### SUMMARY

Apparatuses and methods are presented herein that enable dialing missed inbound telephone calls (i) using human selection with (ii) no random generation of telephone numbers or random storage of missed inbound calls. Missed inbound calls can come from a number of sources, and the phone numbers are stored sequentially in a database. They may be deterministically classified into a number of queues according to a number of characteristics such as the telephone number itself, source of the call, time of day, time zone, day of the week, data source, DNC registry, etc. The queues may be directed to a call selector which deterministically presents a choice of numbers to dial to a human company representative at a workstation. The customer representative may select which number to call, adding the element of human choice to the process.

In an exemplary embodiment, an apparatus comprises: a database configured to record missed inbound telephone calls and associated characteristics; a classifier configured to deterministically direct the missed inbound telephone calls from the database to one or more queues according to the associated characteristics of the missed inbound telephone calls; and a call selector configured to deterministically provide the missed inbound telephone calls or symbols representing them from the one or more queues to a display on a human company representative workstation; wherein the associated characteristics of the missed inbound telephone calls comprise a telephone number and at least one of a data source, a product line, a time zone, a time of day, or a weekday.

In another exemplary embodiment, a human company representative selects one of a plurality of telephone numbers to be displayed on the human company representative workstation. In another exemplary embodiment, the telephone number selected by the human company representative is dialed. In another exemplary embodiment, the telephone number selected by the human company representative is prevented from being redialed. In another exemplary embodiment, the human company representative sets a console limit to determine how many telephone numbers or their symbols are displayed on the human company representative workstation at one time.

In another exemplary embodiment, the plurality of telephone numbers displayed on the human company representative workstation is determined by an identity of the human company representative, the console limit, and the time the display is loaded. In another exemplary embodiment, the time when the telephone number is dialed is logged. In another exemplary embodiment, the classifier receives missed inbound telephone calls in an order in which they are read from the database.

In an exemplary embodiment, a method of deterministically directing missed inbound telephone calls comprises: recording the missed inbound telephone calls and associated characteristics in a database; deterministically classifying the missed inbound telephone calls into queues according to the associated characteristics; and deterministically selecting the missed inbound telephone calls for display on a human company representative workstation; wherein the associated characteristics of the missed inbound telephone calls comprise a telephone number and at least one of a data source, a product line, a time zone, a time of day, or a weekday.

In another exemplary embodiment, a human company representative selects one of a plurality of telephone numbers displayed on the human company representative workstation. In another exemplary embodiment, the telephone number selected by the human company representative is dialed. In another exemplary embodiment, the telephone number selected by the human company representative is prevented from redialing of the telephone number. In another exemplary embodiment, the human company representative sets a console limit to determine how many telephone numbers are displayed on the human company representative workstation at one time.

In another exemplary embodiment, the plurality of telephone numbers displayed on the human company representative workstation is determined by an identity of the human company representative, the console limit, and the time the display is loaded. In another exemplary embodiment, the time when the telephone number is dialed and coordinates of the selected telephone number on the dialer console at the time of dial are logged. In another exemplary embodiment, missed inbound telephone calls are processed in an order in which they are read from the database.

In an exemplary embodiment, a non-transitory computer-readable storage medium configured to store instructions and data to be executed by one or more processors, wherein the instructions, when executed, cause an apparatus to perform steps as follows comprises: recording missed inbound telephone calls and associated characteristics in a database; deterministically classifying the missed inbound telephone calls into queues according to the associated characteristics; and deterministically selecting the missed inbound telephone calls for display on a human company representative workstation; wherein the associated characteristics of the missed inbound telephone calls comprise a telephone number and at least one of a data source, a product line, a time zone, a time of day, or a weekday.

In another exemplary embodiment, a human company representative selects one of a plurality of telephone numbers displayed on the human company representative workstation; the telephone number selected by the human company representative is dialed; and the time when the telephone number is dialed and coordinates of the selected telephone number on the dialer console at the time of dial are logged. In another exemplary embodiment, the human company representative sets a console limit to determine how many telephone numbers are displayed on the human company representative workstation at one time; and the plurality of telephone numbers displayed on the human company representative workstation is determined by an identity of the human company representative, the console limit, and the time the display is loaded. In another exemplary embodiment, the telephone number selected by the human company representative is prevented from redialing of the telephone number.

These and other features of the concepts provided herein may be better understood with reference to the drawings, description, and appended claims.

### BRIEF DESCRIPTION OF DRAWINGS

The above and other aspects, features, and advantages of several embodiments of the present disclosure will be more apparent from the following description as presented in conjunction with the following several figures of the drawings.

FIG. 1 is a schematic block diagram of a human selection dialing platform in accordance with an embodiment of the disclosure;

FIG. 2 is a schematic block diagram of a human selection dialing platform in accordance with an embodiment of the disclosure;

FIG. 3 is a schematic block diagram of a classifier in accordance with an embodiment of the disclosure;

FIG. 4 is a schematic block diagram of a selection console in accordance with an embodiment of the disclosure;

FIG. 5 is a schematic block diagram of a human selection dialing platform in accordance with an embodiment of the disclosure; and

FIG. 6 is a flowchart depicting a process for the operation of a human selection dialing platform in accordance with an embodiment of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements to facilitate understanding of the various presently disclosed embodiments. In addition, common but well-understood elements that are useful or necessary in a commercially feasible embodiment are often not depicted in order to facilitate a less obstructed view of these various embodiments of the present disclosure.

### DETAILED DESCRIPTION

In response to the situations described above, apparatuses and methods are discussed herein that enable dialing missed inbound telephone calls (i) using human selection with (ii) no random generation of telephone numbers or random storage of missed inbound calls. Missed inbound calls can come from a number of sources, and the phone numbers are stored sequentially in a database. They may be deterministically classified into a number of queues according to a number of characteristics such as the telephone number itself, source of the call, time of day, time zone, day of the week, data source, DNC registry, etc. The queues may be directed to a call selector, which deterministically presents a choice of numbers to dial to a human company representative at a workstation. The customer representative may select which number to call, adding the element of human choice to the process.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations, which, when joined logically together, comprise the function and achieve the stated purpose for the function.

Indeed, a function of executable code may include a single instruction or many instructions and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but is not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computers and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

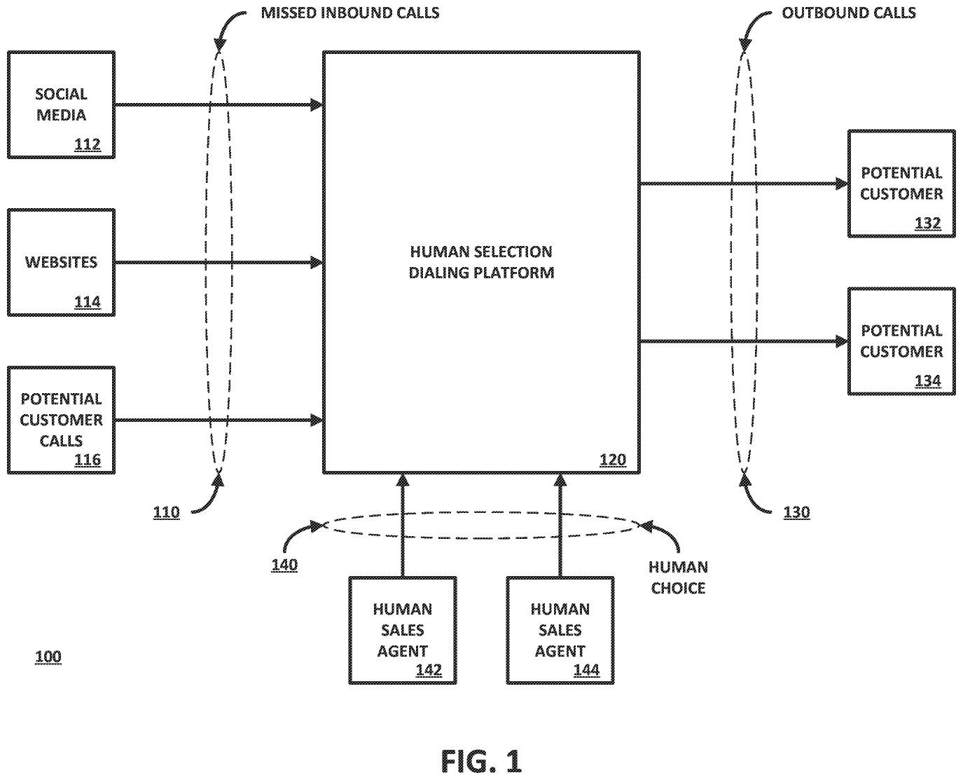

Referring to FIG. 1, a schematic block diagram of a human selection dialing platform in accordance with an embodiment of the disclosure is shown. In system 100, missed inbound calls 110 may be sent to a human selection dialing platform 120. These calls may be sourced from a variety of different places. Inbound calls may originate from social media 112, websites 114, and consumer calls 116. The inbound phone number of the call and its characteristics may be used to determine the source of the missed inbound call.

The human selection dialing platform 120 may use the characteristics of a missed inbound call 110 to place outbound calls 130 to potential customers 132 and 134. The order of the outbound calls may be determined in part by human choice 140 made by exemplary human company representatives 142 and 144.

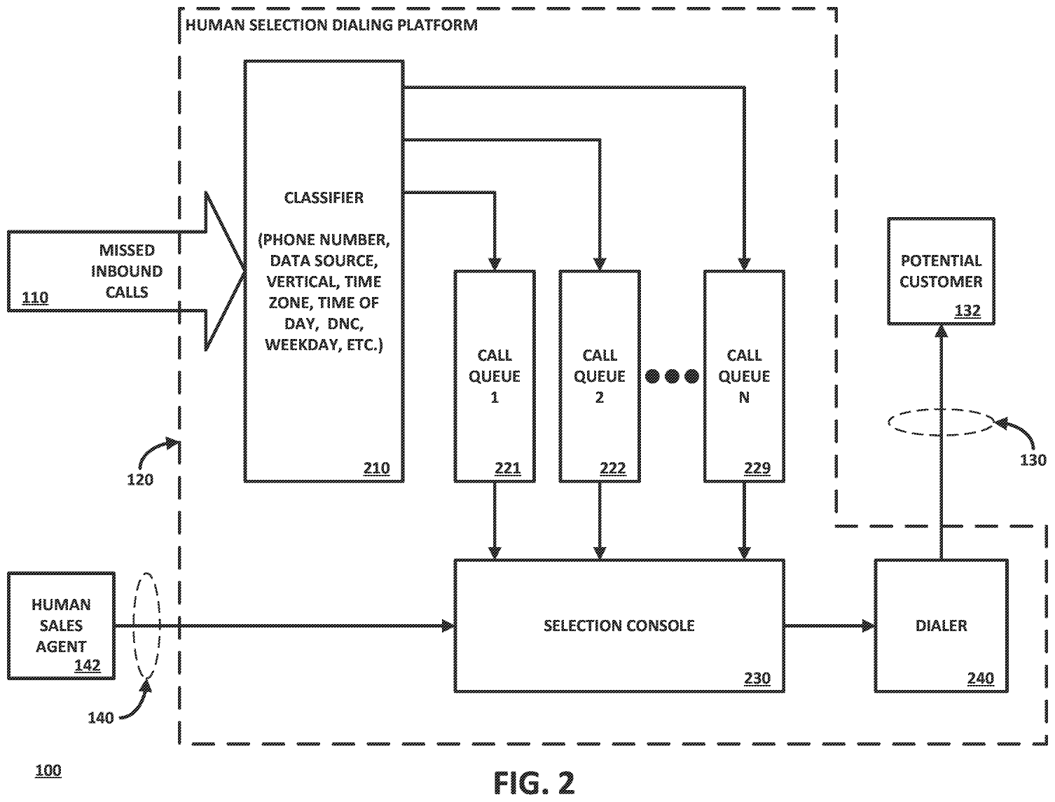

Referring to FIG. 2, a schematic block diagram of a human selection dialing platform in accordance with an embodiment of the disclosure is shown. The human selection dialing platform 120 may comprise a classifier 210. Classifier 210 may comprise a database where missed inbound calls 110 may be stored in the order in which they come in. Classifier 210 may process these calls in the order they are read from the database and may send them to a plurality of call queues 221, 222, to 229.

The queues may then provide phone numbers to the selection console 230. Company representatives may choose a call from the plurality of the phone numbers provided to the selection console 230. When a company representative selects a telephone number (e.g., by moving a cursor over a circle containing the telephone number on a computer screen), dialer 240 may place an outbound call 130 to potential customer 132.

The plurality of call queues 221, 222, to 229 depends on the characteristics of each missed inbound call 110. For example, a customer may have called at 2:30 PM on a Tuesday, which suggests that the same time and day of the week might be a good time to try and reach the potential customer 132. In another example, the missed call may have been made concerning a particular vertical (e.g., a product line), and a queue may direct the missed inbound call 110 to a company representative who specializes in that vertical. In such cases, the company may have different inbound phone numbers, and those can be used to identify the vertical the customer is interested in.

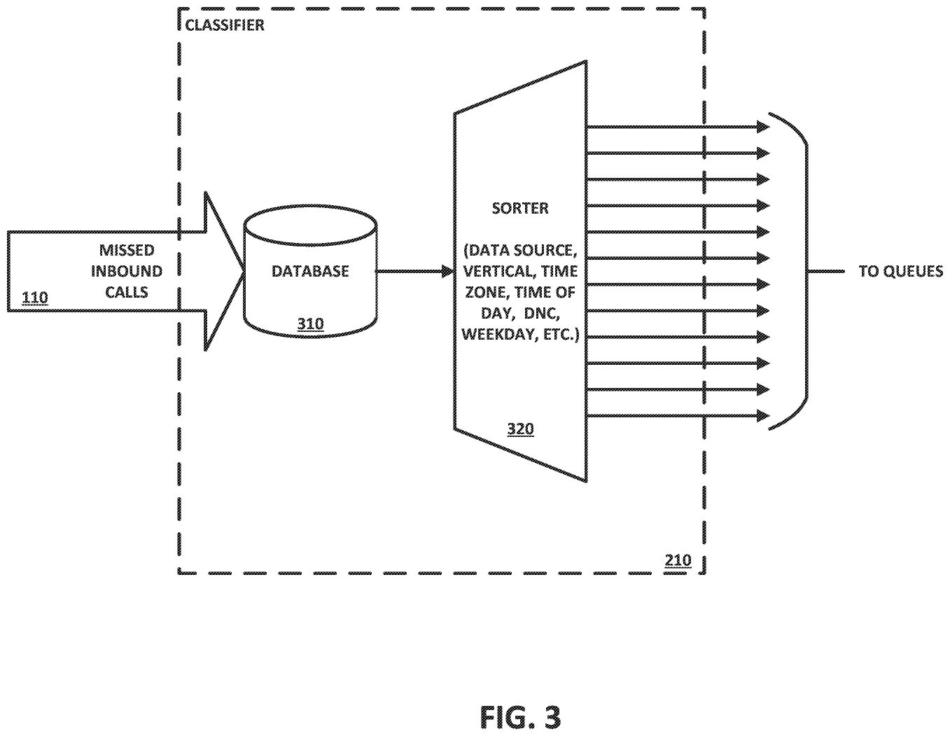

Referring to FIG. 3, a schematic block diagram of a classifier in accordance with an embodiment of the disclosure is shown. The classifier 210 may comprise a database 310 and a sorter 320. The missed inbound calls 110 may be stored in database 310 in the order they came in. The database 310 may be read to present the sorter inbound phone numbers in the order in which they were received from the missed inbound calls 110.

The sorter 320 may receive the inbound phone numbers read from the database 310 and processes them deterministically. The sorter 320 may use the characteristics of each telephone number to sort them into a plurality of queues. Calls may be sorted by data source, vertical, time zone, time of day, weekday, etc. Calls from numbers on the DNC registry are automatically rejected by sorter 320.

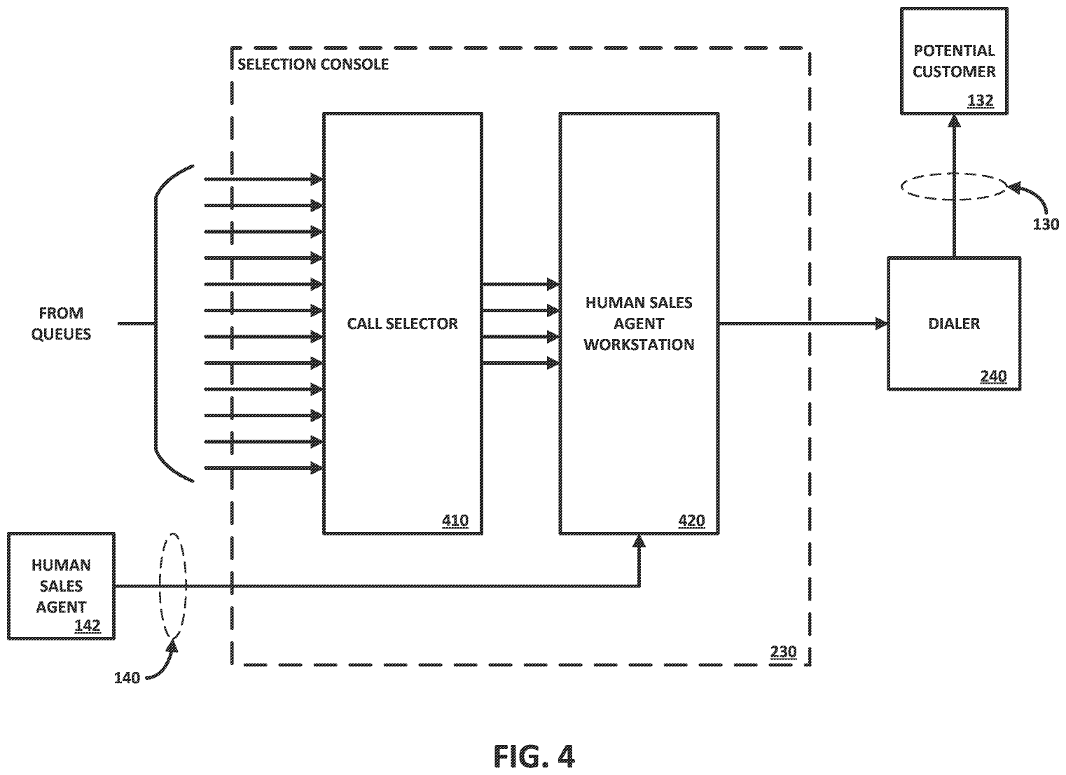

Referring to FIG. 4, a schematic block diagram of a selection console in accordance with an embodiment of the disclosure is shown. Selection console 230 may comprise a call selector 410 and a human company representative workstation 420. The call selector 410 may receive telephone numbers from the plurality of call queues 221, 222, to 229. The human selection dialing platform 120 may have no randomization at any point in the flow of the data from database 310 to the human company representative workstation 420.

For each call campaign, data may be loaded into sorter 320 in the order it is read from database 310. The plurality of call queues 221, 222, to 229 may load campaign data for the selection console 230. The plurality of call queues 221, 222, to 229 may follow a designed set of rules to ensure TCPA/Time Zone compliance and to prevent human company representatives from selecting and redialing the same phone number (e.g., dialing twice). To ensure TCPA/Time Zone compliance, the queue will prioritize certain time zones.

For example, TCPA laws prohibit calling before 8:00 AM in most states. If a campaign starts at 8:00 AM EST, only EST may be queued between 8:00 AM and 9:00 AM. Between 9:00 AM and 10:00 AM EST, both EST and CST may be queued, and so on. After 11:00 AM EST, all four continental US time zones are open.

For a second example, in order to prevent exemplary human company representatives 142 and 144 from selecting and dialing the same phone number (e.g., dialing twice), and without using any randomization, the human selection dialing platform 120 will determine the queue order for each exemplary human company representatives 142 and 144, based on the computer identity of the exemplary human company representatives 142 and 144 (e.g., user name, user number, or other identifier unique to the exemplary human company representative).

For a third example, a consumer who opts in (e.g., by calling to initiate contact) to speak about an Auto Insurance review is often a perfect candidate for an Auto and Home bundle policy option; however, the TCPA law prevents us from being able to discuss those options with them. Through the human selection dialing platform 120 platform, we can re-engage with consumers who are potentially interested in the bundle opportunity.

For a fourth example, an SSDI lead may be eligible for Medicare and can now be contacted to help support their Medicare review process. There are many other use cases for the human selection dialing platform 120.

Human company representative workstation 420 places the selected telephone numbers from the call selector 410 to exemplary human company representative 142 in a format that can be acted upon. The human selection dialing platform 120 uses a deterministic method to build a list of phone numbers to be dialed and human choice as a method of dial selection/ordering. Deterministic list generation criteria are based, for example, on the data source, vertical, DNC, and day of the week. The same data source, vertical, DNC, and weekday will deterministically produce the exact same list of numbers to be dialed in the same order. There may be no attempted randomization of the data at any point in this process.

The human company representative workstation may be designed to connect the exemplary human company representative 142 to the deterministically generated phone list. Exemplary human company representative 142 can select the number of phone numbers displayed in the human company representative workstation 420. Depending on the display quantity selected, a static pattern of circles representing each phone number may be rendered on a computer display. For example, exemplary human company representative 142 may use their mouse to drag the pointer over a circle to initiate the call. Once all the circles are selected, the page may refresh with a new set of circles/phone numbers. The displayed pattern of circles/numbers and the path of the mouse pointer are controlled by the exemplary human company representative 142, and this may be where human choice takes over from the deterministic processes. The time when the exemplary human company representative 142 may make their selection and the mouse coordinates on the circles/numbers at the time of dial are logged by the human selection dialing platform 120. The dialer 240 may then place the phone call to potential customer 132.

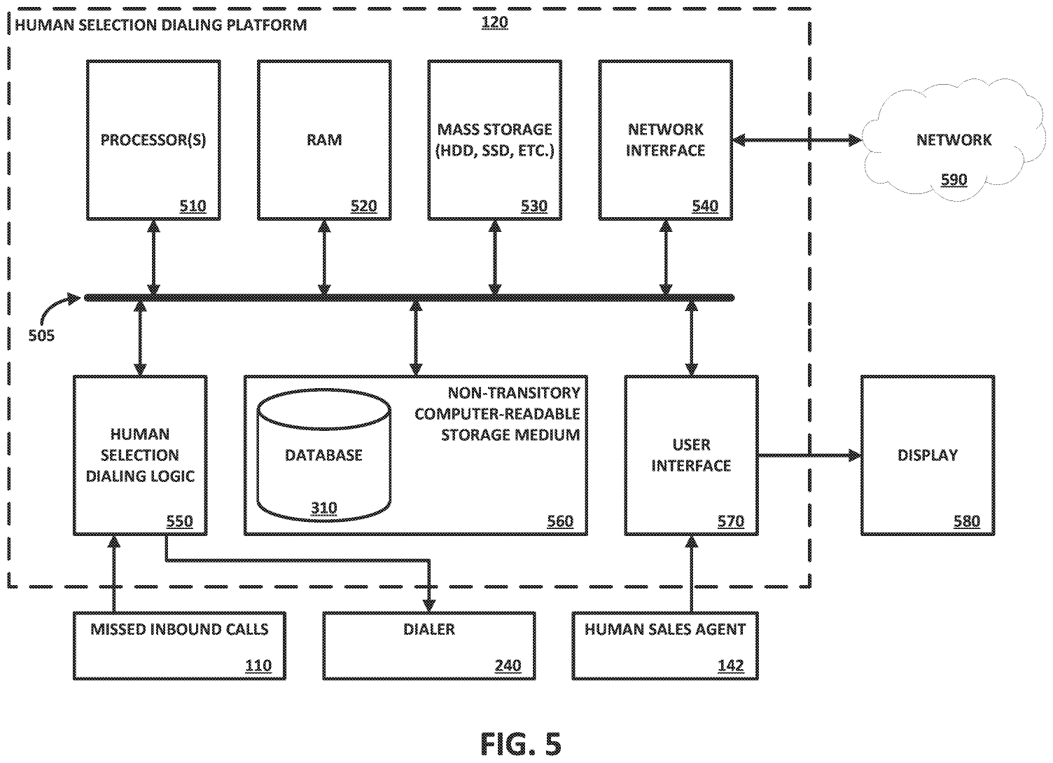

Referring to FIG. 5, a schematic block diagram of a human selection dialing platform in accordance with an embodiment of the disclosure is shown. Human selection dialing platform 120 may comprise a processor 510 and a bus 505. Processor 510 may be coupled to several memories, including RAM 520, mass storage 530, and non-transitory computer-readable storage medium 560 via bus 505. The non-transitory computer-readable storage medium 560 may be the location of database 310 and may store some of the computer executable code 565 that runs on processor 510. The instructions in the code may cause processor 510 to perform instructions and/or steps to execute the operation of the human selection dialing platform 120.

Also present in FIG. 5 are network interface 540 and user interface 570, both coupled to bus 505. Network interface 540 may be coupled to a network 590 (e.g., a LAN, a WAN, the Internet, etc.). This may allow the human selection dialing platform to communicate with external databases like, for example, the national DNC registry.

Display 580 may be controlled by user interface 570 and is used for displaying, among other things, the circles representing phone numbers to be selected and dialed by human selection dialing platform 120. An exemplary human company representative 142 may operate the human selection dialing platform 120 via user interface 570.

Also present is human selection dialing logic 550. This particular module may be software, hardware (e.g., in an FPGA, an ASIC, a PAL, etc.), or a combination thereof and may be responsible for most of the discussed functionality of human selection dialing platform 120. It may communicate with the processor 510, the various memory modules (RAM 520, mass storage 530, and non-transitory computer-readable storage medium 560), network interface 540, and user interface 570.

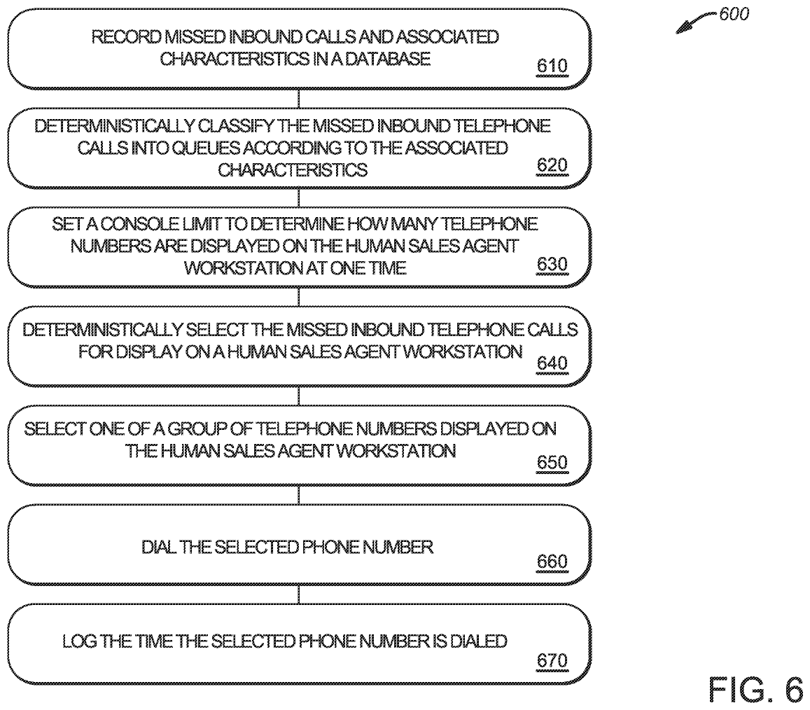

Referring to FIG. 6, a flowchart depicting a process 600 for the operation of a human selection dialing platform in accordance with an embodiment of the disclosure is shown. Process 600 may begin by recording inbound telephone calls and associated characteristics and storing them in a database (block 610). Missed inbound telephone calls can come from multiple sources such as social media, websites, and other sources (e.g., magazine ads, postcard ads, etc.). They may be stored in the database in the order they come in. This process must be deterministic and non-random.

Process 600 may proceed with deterministically classifying the inbound telephone calls into queues according to their characteristics (block 620). The inbound telephone calls may be processed in the order in which they may be read from the database.

A human company representative may select the appearance of the display. In particular, the human company representative may set a console limit to determine how many telephone numbers are displayed on the human company representative workstation at one time (block 630). In some embodiments, the number of numbers displayed may be 5, 6, 8, 9, and 10, though other numbers may be used as a matter of design choice. A pattern of circles may be displayed, though any symbol may be used (e.g., squares, rectangles, stars, etc.). The distribution pattern on the display may be determined by the human company representative's selected console limit and the time of day. There are two pattern options per console limit. Factoring in the current time at page load, if the seconds value is even, the first pattern will display. If the seconds value is odd, the alternate pattern appears.

It should be noted that symbols may or may not display the associated phone number to the exemplary human company representative 142. Thus it should be recognized by those skilled in the art that saying a phone number is displayed can mean literally the phone number, a symbol representing the phone number, or a symbol including the phone number is displayed, even if the language only describes one of these options.

Process 600 may deterministically select the missed inbound telephone calls (or their symbols) for display on a human company representative workstation (block 640). These may be drawn from one or more of the queues holding the classified data. The human company representative may select one of a group of telephone numbers displayed on the human company representative workstation (block 650). The human company representative may select a phone number by moving a mouse (or other cursor control device) over one of the circles (or other symbols) on the display, and the selected phone number is dialed (block 660). The time of the outgoing phone call and the mouse coordinates on the dialer console at the time of dial are then logged by the system (block 670).

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure for solutions to such problems to be encompassed by the present claims. Furthermore, no element, component, or method step in the present disclosure is intended to be dedicated to the public, regardless of whether the element, component, or method step is explicitly recited in the claims. Various changes and modifications in form, material, work-piece, and fabrication material detail can be made without departing from the spirit and scope of the present disclosure, as set forth in the appended claims, as might be apparent to those of ordinary skill in the art, are also encompassed by the present disclosure.

What is claimed is:

1. An apparatus, comprising:
a database configured to record missed inbound telephone calls and associated characteristics;
a classifier configured to deterministically direct the missed inbound telephone calls from the database to one or more queues according to the associated characteristics of the missed inbound telephone calls; and
a call selector configured to deterministically provide the missed inbound telephone calls or symbols representing them from the one or more queues to a display on a human company representative workstation;
wherein the associated characteristics of the missed inbound telephone calls comprise a telephone number and at least one of a data source, a product line, a time zone, a time of day, or a weekday.

2. The apparatus of claim 1, wherein a human company representative selects one of a plurality of telephone numbers to be displayed on the human company representative workstation.

3. The apparatus of claim 2, wherein the telephone number selected by the human company representative is dialed.

4. The apparatus of claim 3, wherein the telephone number selected by the human company representative is prevented from being redialed.

5. The apparatus of claim 2, wherein the human company representative sets a console limit to determine how many telephone numbers or their symbols are displayed on the human company representative workstation at one time.

6. The apparatus of claim 5, wherein the plurality of telephone numbers displayed on the human company representative workstation is determined by an identity of the human company representative, the console limit, and the time the display is loaded.

7. The apparatus of claim 3, wherein the time when the telephone number is dialed is logged.

8. The apparatus of claim 1, wherein the classifier receives missed inbound telephone calls in an order in which they are read from the database.

9. A method of deterministically directing missed inbound telephone calls, the method comprising:
recording the missed inbound telephone calls and associated characteristics in a database;
deterministically classifying the missed inbound telephone calls into queues according to the associated characteristics; and
deterministically selecting the missed inbound telephone calls for display on a human company representative workstation;
wherein the associated characteristics of the missed inbound telephone calls comprise a telephone number and at least one of a data source, a product line, a time zone, a time of day, or a weekday.

10. The method of claim 9, wherein a human company representative selects one of a plurality of telephone numbers displayed on the human company representative workstation.

11. The method of claim 10, wherein the telephone number selected by the human company representative is dialed.

12. The method of claim 11, wherein the telephone number selected by the human company representative is prevented from redialing of the telephone number.

13. The method of claim 10, wherein the human company representative sets a console limit to determine how many telephone numbers are displayed on the human company representative workstation at one time.

14. The method of claim 13, wherein the plurality of telephone numbers displayed on the human company representative workstation is determined by an identity of the human company representative, the console limit, and the time the display is loaded.

15. The method of claim 11, wherein the time when the telephone number is dialed and coordinates of the selected telephone number on the dialer console at the time of dial are logged.

16. The method of claim 9, wherein missed inbound telephone calls are processed in an order in which they are read from the database.

17. A non-transitory computer-readable storage medium configured to store instructions and data to be executed by one or more processors, wherein the instructions, when executed, cause an apparatus to perform steps as follows, comprising:
recording missed inbound telephone calls and associated characteristics in a database;
deterministically classifying the missed inbound telephone calls into queues according to the associated characteristics; and
deterministically selecting the missed inbound telephone calls for display on a human company representative workstation;
wherein the associated characteristics of the missed inbound telephone calls comprise a telephone number and at least one of a data source, a product line, a time zone, a time of day, or a weekday.

18. The non-transitory computer-readable storage medium of claim 17, wherein:
a human company representative selects one of a plurality of telephone numbers displayed on the human company representative workstation;
the telephone number selected by the human company representative is dialed; and
the time when the telephone number is dialed and coordinates of the selected telephone number on the dialer console at the time of dial are logged.

19. The non-transitory computer-readable storage medium of claim 18, wherein:
the human company representative sets a console limit to determine how many telephone numbers are displayed on the human company representative workstation at one time; and
the plurality of telephone numbers displayed on the human company representative workstation is determined by an identity of the human company representative, the console limit, and the time the display is loaded.

20. The non-transitory computer-readable storage medium of claim 19, wherein the telephone number selected by the human company representative is prevented from redialing of the telephone number.
